(19) United States
(12) Patent Application Publication
(10) Pub. No.: US 2026/0217936 A1
(43) Pub. Date: Jul. 30, 2026

(54) RESIN RECOVERY METHOD

(71) Applicant: HONDA MOTOR CO., LTD., Tokyo (JP)

(72) Inventors: Haruki CHIBA, Saitama (JP); Yasushi TERASAKA, Saitama (JP)

(21) Appl. No.: 19/424,167

(22) Filed: Dec. 18, 2025

(30) Foreign Application Priority Data
Jan. 24, 2025 (JP) 2025-010234

(51) Int. Cl. C08J 11/08; C08K 7/06; C08K 7/14

(52) U.S. Cl. CPC C08J 11/08; C08K 7/06; C08K 7/14; C08J 2377/02; C08J 2377/06

(57) ABSTRACT

A method for recovering resin from a fiber-reinforced resin provides a resin recovery method including the steps of: dissolving a resin contained in the fiber-reinforced resin in ethylene glycol, solid-liquid separating into a solution in which the resin is dissolved in ethylene glycol, and fiber, heating concentrating the solution to obtain a concentrated liquid, and cutting the concentrated liquid, in which upon heating concentration of the solution, the solution is concentrated at a temperature at which the resin contained in the concentrated liquid is melted, and the resin contained in the concentrated liquid to be cut is melted.

This application is based on and claims the benefit of priority from Japanese Patent Application No. 2025-010234, filed on 24 January 2025, the content of which is incorporated herein by reference.

### BACKGROUND OF THE INVENTION

### Field of the Invention

The present invention relates to a method for recovering resin from a fiber reinforced resin.

### Related Art

In recent years, efforts directed at a significant reduction in the generation of waste materials are becoming more active, by the prevention or reduction of waste generation, recycling and reuse. Towards this realization, research and development is being carried out into recycling of waste plastic materials.

Japanese Unexamined Patent Application, Publication No. 2000-80199 describes a method of dissolving polyamide by adding a phosphoric acid aqueous solution with a concentration of 70 wt% or more to a polyamide molded article containing glass fibers, and heating while stirring, and subsequently separating the polyamide solution and glass fibers.

Patent Document 1: Japanese Unexamined Patent Application, Publication No. 2000-80199

### SUMMARY OF THE INVENTION

However, when employing the method described in Japanese Unexamined Patent Application, Publication No. 2000-80199, the molecular weight of the recycled polyamide declines.

The present invention has an object of providing a resin recovery method capable of suppressing a decline in molecular weight.

(1) A resin recovery method for recovering resin from a fiber-reinforced resin includes the steps of: dissolving a resin contained in the fiber-reinforced resin into ethylene glycol; solid-liquid separating into a solution in which the resin is dissolved in ethylene glycol, and fiber; heating concentrating the solution to obtain a concentrated liquid; and cutting the concentrated liquid, in which upon heating concentration of the solution, the solution is concentrated at a temperature at which the resin contained in the concentrated liquid is melted, and the resin contained in the concentrated liquid to be cut is melted.

(2) In the resin recovery method as described in (1), the solution is concentrated at a temperature of 150°C or more and 300°C or less, upon heating concentration of the solution.

(3) In the resin recovery method as described in (1) or (2), the solution is stirred upon the heating concentration.

(4) In the resin recovery method as described in any one of (1) to (3), pressure is reduced upon the heating concentration of the solution.

(5) In the resin recovery method as described in any one of (1) to (4), upon heating concentration of the solution, the solution is heating concentrated to obtain a first concentrated liquid, followed by heating concentration of the first concentrated liquid to obtain a second concentrated liquid, the first concentrated liquid has an ethylene glycol concentration of 8% by mass or more and 23% by mass or less, and the second concentrated liquid has an ethylene glycol concentration of 2% by mass or more and 5% by mass or less.

According to the present invention, it is possible to provide a resin recovery method capable of suppressing a decline in molecular weight.

### DETAILED DESCRIPTION OF THE INVENTION

Hereinafter, an embodiment of the present invention will be described.

A resin recovery method according to the present embodiment is a method for recovering resin from a fiber-reinforced resin. The fiber-reinforced resin is not particularly limited; however, the crushed material of intake manifolds can be exemplified. The fibers constituting the fiber-reinforced resin are not particularly limited; however, glass fibers and carbon fibers can be exemplified. The resin constituting the fiber-reinforced resin is not particularly limited so long as able to dissolve in ethylene glycol; however, polyamides such as nylon 6 and nylon 66 can be exemplified.

Hereinafter, each step of the resin recovery method according to the present embodiment will be described.

### Dissolution Step

First, the resin contained in the fiber-reinforced resin is dissolved in ethylene glycol. The method of dissolving the resin contained in the fiber-reinforced resin in ethylene glycol is not particularly limited; however, a method which mixes the fiber-reinforced resin and ethylene glycol, then heat refluxes can be exemplified. At this time, the heat refluxing temperature is not particularly limited so long as being a temperature less than the boiling point of ethylene glycol; however, it is 150°C or more and 170°C or less, for example.

### Solid-liquid Separation Step

It is solid-liquid separated into a solution in which the resin is dissolved in ethylene glycol, and fibers. The method of solid-liquid separating is not particularly limited; however, a method of filtering with a filter, and a method of centrifuging can be exemplified.

### Heating Concentration Step

A concentrated liquid is obtained by heating concentration of the solution. The concentration of ethylene glycol in the concentrated liquid is not particularly limited; however, it is 2% by mass or more and 5% by more or less, for example. At this time, the heating concentration temperature is a temperature at which the resin contained in the concentrated liquid melts. As described later, heat loss is suppressed since the resin contained in the concentrated liquid to be cut is melted. The heating concentration temperature is preferably 150°C or more and 300°C or less. If the heating concentration temperature is 150°C or more, the resin will easily dissolve in the ethylene glycol, and when 300°C or less, a decline in the resin molecular weight is suppressed.

Upon heating concentration of the solution, it is preferable to stir the solution. The heating concentration time is thereby shortened. In addition, upon heating concentration of the solution, it is preferable to reduce pressure. The heating concentration time is thereby shortened. At this time, the degree of pressure reduction is not particularly limited; however, it is 20 kPa or more and 100 kPa or less, for example.

Upon heating concentration of the solution, the solution is heating concentrated to obtain a first concentrated liquid, followed by heating concentration of the first concentrated liquid to obtain a second concentrated liquid, and the concentration of ethylene glycol in the first concentrated liquid is preferably 8% by mass or more and 23% by mass or less, and the concentration of ethylene glycol in the second concentrated liquid is preferably 2% by mass or more and 5% by mass or less. Explosive boiling upon cutting the second concentrated liquid in water is thereby suppressed. The degree of pressure reduction upon obtaining the first concentrated liquid is not particularly limited; however, it is 20 kPa or more and less than 80 kPa, for example. In addition, the degree of reduced pressure upon obtaining the second concentrated liquid is not particularly limited; however, it is 80 kPa or more and 100 kPa or less, for example.

Since the second concentrated liquid has higher viscosity than the first concentrated liquid, a mixer blade for low viscosity (for example, Maxblend blade) is preferably used as necessary upon obtaining the first concentrated liquid, and a mixer blade for high viscosity (for example, helical ribbon blade) is preferably used upon obtaining the second concentrated liquid. The manufacturing stability upon heating concentration of the solution to produce a concentrated liquid thereby improves.

A concentration kettle is preferably used upon heating concentration of the solution. The ethylene glycol distilled from the solution can thereby be recovered.

### Cutting Step

The concentrated liquid is cut to obtain the recycled resin. The resin contained in the concentrated liquid to be cut is melted. Herein, the heating concentration temperature is a temperature at which the resin contained in the concentrated liquid is melted, and thus the heat loss is suppressed. It should be noted that the temperature of the concentrated liquid to be cut is not particularly limited so long as capable of melting the resin; however, it is 150°C or more and 300°C or less, for example.

The residual amount of ethylene glycol in the recycled resin is not particularly limited; however, it is 1% by mass or less, for example. The form of the recycled resin is not particularly limited; however, pellets can be exemplified.

The concentrated liquid is preferably cut in water. Since the ethylene glycol contained in the concentrated liquid elutes in water, the residual amount of ethylene glycol in the recycled resin is thereby reduced. The temperature of the water is not particularly limited so long as able to cut the concentrated liquid in water; however, it is 50°C or more and 60°C or less, for example.

Upon cutting the concentrated liquid in water, an underwater cutting-type pelletizer is preferably used. The ethylene glycol eluted in the water can thereby be recovered.

Although an embodiment of the present invention has been described above, the present invention is not limited to the above embodiment, and the above embodiment may be modified as appropriate within the scope of the gist of the present invention.

### EXAMPLES

Although examples of the present invention will be described below, the present invention is not to be limited to the examples.

### Example 1

### Dissolution Step

The waste material of glass fiber-reinforced nylon 6 (crushed material of intake manifolds; number average molecular weight (Mn) of nylon 6: 12,000) and ethylene glycol are mixed so as to make the mass ratio of nylon to ethylene glycol of 1:3 (50 kg: 150 kg), followed by heating reflux for 1 hour at 170°C, whereby the nylon 6 was dissolved in ethylene glycol to obtain a liquid mixture. Herein, the glass fiber-reinforced nylon 6 has a mass ratio of nylon 6 to glass fiber of 70:30.

### Solid-liquid Separation Step

The liquid mixture having a liquid temperature of 170°C was filtered with a filter having an opening size of 20 μm to solid-liquid separate into an ethylene glycol solution of nylon 6, and glass fibers.

### Heating Concentration Step

After feeding 200 kg of the ethylene glycol solution of nylon 6 to a first concentration kettle, the ethylene glycol was distilled until the concentration of ethylene glycol reached 8.0% by mass, while further stirring with a Maxblend blade under conditions of 170°C temperature and 20 kPa reduced pressure, thereby obtaining 54 kg of the first concentrated liquid. At this time, the temperature increased to reach 280°C, accompanying the progression of the concentration of the ethylene glycol solution of nylon 6. Herein, 280°C is a temperature exceeding the melting temperature, which is no more than the melting point (220°C) of nylon 6.

After feeding 54 kg of the first concentrated liquid to a second concentration kettle, the ethylene glycol was distilled until the concentration of ethylene glycol reached 3.0% by mass, while further stirring with a helical ribbon blade as a stirring blade for high viscosities, under conditions of 280°C temperature and 80 kPa reduced pressure, thereby obtaining 51.5 kg of the second concentrated liquid. At this time, the nylon 6 contained in the second concentrated liquid had melted.

### Cutting Step

Using a gear pump, the second concentrated liquid was supplied to an underwater cutting-type pelletizer under the following conditions to cut the second concentrated liquid and obtain recycled nylon 6 pellets. At this time, the nylon 6 contained in the second concentrated liquid to be cut was melted. In addition, the recycled nylon 6 pellets had a number average molecular weight (Mn) of 9,800, a residual amount of ethylene glycol of 1.0% by mass or less, and a diameter of 3.2 mm. In addition, there was no explosive boiling upon cutting the second concentrated liquid.

Feed rate of second concentrated liquid: 10 kg/h

Temperature of die heater: 280°C

Rotation speed of rotary blade: 3000 rpm

What is claimed is:

1. A resin recovery method for recovering resin from a fiber-reinforced resin, the method comprising the steps of:
dissolving a resin contained in the fiber-reinforced resin into ethylene glycol;
solid-liquid separating into a solution in which the resin is dissolved in ethylene glycol, and fiber;
heating concentrating the solution to obtain a concentrated liquid; and
cutting the concentrated liquid,
wherein, upon heating concentration of the solution, the solution is concentrated at a temperature at which the resin contained in the concentrated liquid is melted, and
wherein the resin contained in the concentrated liquid to be cut is melted.

2. The resin recovery method according to claim 1, wherein the solution is concentrated at a temperature of 150°C or more and 300°C or less, upon heating concentration of the solution.

3. The resin recovery method according to claim 1, wherein the solution is stirred upon the heating concentration.

4. The resin recovery method according to claim 1, wherein pressure is reduced upon the heating concentration of the solution.

5. The resin recovery method according to claim 1, wherein upon heating concentration of the solution, the solution is heating concentrated to obtain a first concentrated liquid, followed by heating concentration of the first concentrated liquid to obtain a second concentrated liquid,
wherein the first concentrated liquid has an ethylene glycol concentration of 8% by mass or more and 23% by mass or less, and
wherein the second concentrated liquid has an ethylene glycol concentration of 2% by mass or more and 5% by mass or less.
